(19) United States
(12) Patent Application Publication
(10) Pub. No.: US 2022/0165124 A1
(43) Pub. Date: May 26, 2022

(54) METHOD FOR COMMUNICATING AMONG USERS OF A WAGERING NETWORK

(71) Applicant: AdrenalineIP, Washington, DC (US)

(72) Inventors: Casey Alexander HUKE, Washington, DC (US); John CRONIN, Jericho, VT (US); Joseph W. BEYERS, Saratoga, CA (US); Michael D'ANDREA, Burlington, VT (US)

(73) Assignee: AdrenalineIP, Washington, DC (US)

(21) Appl. No.: 17/533,330

(22) Filed: Nov. 23, 2021

Related U.S. Application Data
(60) Provisional application No. 63/117,030, filed on Nov. 23, 2020.

(51) Int. Cl. G07F 17/32

(52) U.S. Cl. CPC G07F 17/3223; G07F 17/3288

(57) ABSTRACT

The present disclosure provides a method of celebrating or taunting users of a wagering network through sportograms, or sport-related animations or pictures, by allowing a user to subscribe to a sportogram database, allowing a user to connect to various other users of a wagering network, monitoring connected users open wagers to determine if there are related characteristics in a live event to the subscribed sportogram libraries, and allowing a user to send a sportogram to a connected user.

### FIELD

The present disclosures are generally related to in-play wagering on live sporting events.

### BACKGROUND

On a wagering platform or wagering application, users cannot taunt their opponents, friends, users in their contact list, etc., unless it is through textual means.

Also, users are limited on wagering platforms and wagering applications in how they can celebrate or taunt other users when winning a wager or before a wager result becomes known.

Lastly, there are not specific sports wagering-related emojis, gifs, animations, or pictures that users can send one another through a wagering platform or wagering application.

Thus, there is a need in the prior art to allow users to taunt or celebrate through various types of animations or pictures.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: illustrates a system for celebrating or taunting users of a wagering network, according to an embodiment.

FIG. 2: illustrates a sportogram base module, according to an embodiment.

FIG. 3: illustrates a subscription module, according to an embodiment.

FIG. 4: illustrates a connection module, according to an embodiment.

FIG. 5: illustrates a monitoring module, according to an embodiment.

FIG. 6: illustrates a delivery module, according to an embodiment.

FIG. 7: illustrates a sportogram database, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. The described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, and/or hit performed by a participant in a sporting event. In some embodiments, an action may be a strategic decision made by a participant in the sporting event, such as a player, coach, management, etc. In some embodiments, an action may be a penalty, foul, or other type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity based on the outcome of a future event, such as the results of a game or event. It may be understood that non-monetary items may be the subject of a “bet” or “wager” as well, such as points or anything else that can be quantified for a “bet” or “wager.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be made for certain amount or for a future time. A “bet” or “wager” can be made for being able to answer a question correctly. A “bet” or “wager” can be made within a certain period. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain to place bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example, up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sportsbook has reduced its betting limits, usually because of weather or the uncertain status of injured players, is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides,” “favorite,” “chalk,” “circled game,” “laying the points price,” “dog,” and “underdog” can be integrated into the embodiments in a variety of manners.

The “money line” refers to the odds expressed in terms of money. With money odds, whenever there is a minus (−), the player “lays” or is “laying” that amount to win (for example, $100); where there is a plus (+), the player wins that amount for every $100 wagered. A “straight bet” refers to an individual wager on a game or event that will be determined by a point spread or money line. The term “straight-up” means winning the game without any regard to the “point spread,” a “money-line” bet. “Money line,” “straight bet,” and “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread.” A handicap of the “point spread” value is given to the favorite team so bettors can choose sides at equal odds. “Cover the spread” means that a favorite wins an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread.” The “opening line” means the earliest line posted for a particular sporting event or game. The term “pick” or “pick 'em” refers to a game when neither team is favored in an event or game. “Line,” “cover the spread,” “cover,” “tie,” “pick,” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. The event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total,” “over,” and “under” can be integrated into the embodiments in a variety of manners.

A “parlay” is a single bet that links together two or more wagers; to win the bet, the player must win all the wagers in the “parlay.” If the player loses one wager, the player loses the entire bet. However, if they win all the wagers in the “parlay,” the player may receive a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay,” “round robin,” “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games, and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events. Typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both pitchers scheduled to start a game start. If they do not, the bet is deemed “no action” and refunded. The “run line” in baseball refers to a spread used instead of the money line. “Listed pitchers,” “no action,” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle,” “juice,” vigorish,” “vig,” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individuals that would deploy, for fees, and may be part of, or perform, various system elements or method steps in the embodiments.

Managed service user interface service is a service that can help customers (1) manage third parties, (2) develop the web, (3) perform data analytics, (4) connect thru application program interfaces and (4) track and report on player behaviors. A managed service user interface can be integrated into the embodiments in a variety of manners.

Managed service risk management service are services that assist customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling, and (4) customer service assistance. These managed service compliance services can be integrated into the embodiments in a variety of manners.

Managed service pricing and trading service is a service that helps customers with (1) official data feeds, (2) data visualization, and (3) land based on property digital signage. These managed service pricing and trading services can be integrated into the embodiments in a variety of manners.

Managed service and technology platforms are services that help customers with (1) web hosting, (2) IT support, and (3) player account platform support. These managed service and technology platform services can be integrated into the embodiments in a variety of manners.

Managed service and marketing support services are services that help customers (1) acquire and retain clients and users, (2) provide for bonusing options, and (3) develop press release content generation. These managed service and marketing support services can be integrated into the embodiments in a variety of manners.

Payment processing services are services that help customers with (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat players to free bets, odds boosts, enhanced access, and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by always managing commission and availability. The “cash out” or “pay out” or “payout” can be integrated into the embodiments in a variety of manners, including both monetary and non-monetary payouts, such as points, prizes, promotional or discount codes, and the like.

“Customized betting” allows customers to have tailored personalized betting experiences with sophisticated tracking and analysis of players' behavior. “Customized betting” can be integrated into the embodiments in a variety of manners.

Kiosks are devices that offer interactions with customers, clients, and users with a wide range of modular solutions for both retail and online sports gaming. Kiosks can be integrated into the embodiments in a variety of manners.

Business Applications are an integrated suite of tools for customers to manage the everyday activities that drive sales, profit, and growth by creating and delivering actionable insights on performance to help customers to manage the sports gaming. Business Applications can be integrated into the embodiments in a variety of manners.

State-based integration allows for a given sports gambling game to be modified by states in the United States or other countries, based upon the state the player is in, mobile phone, or other geolocation identification means. State-based integration can be integrated into the embodiments in a variety of manners.

Game Configurator allows for configuration of customer operators to have the opportunity to apply various chosen or newly created business rules on the game as well as to parametrize risk management. The Game Configurator can be integrated into the embodiments in a variety of manners.

“Fantasy sports connectors” are software connectors between method steps or system elements in the embodiments that can integrate fantasy sports. Fantasy sports allow a competition in which participants select imaginary teams from among the players in a league and score points according to the actual performance of their players. For example, if a player in fantasy sports is playing at a given real-time sport, odds could be changed in the real-time sports for that player.

Software as a service (or SaaS) is a software delivery and licensing method in which software is accessed online via a subscription rather than bought and installed on individual computers. Software as a service can be integrated into the embodiments in a variety of manners.

Synchronization of screens means synchronizing bets and results between devices, such as TV and mobile, PC, and wearables. Synchronization of screens can be integrated into the embodiments in a variety of manners.

Automatic content recognition (ACR) is an identification technology that recognizes content played on a media device or present in a media file. Devices containing ACR support enable users to quickly obtain additional information about the content they see without any user-based input or search efforts. A short media clip (audio, video, or both) is selected to start the recognition. This clip could be selected from within a media file or recorded by a device. Through algorithms such as fingerprinting, information from the actual perceptual content is taken and compared to a database of reference fingerprints, wherein each reference fingerprint corresponds with a known recorded work. A database may contain metadata about the work and associated information, including complementary media. If the media clip's fingerprint is matched, the identification software may return the corresponding metadata to the client application. For example, during an in-play sports game, a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet”—which is a computer-generated data point—is placed above the player that is bet on. Augmented reality can be integrated into the embodiments in a variety of manners.

Some embodiments of this disclosure, illustrating all its features, will now be discussed in detail. It can be understood that the embodiments are intended to be open-ended in that an item or items used in the embodiments is not meant to be an exhaustive listing of such item or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described. may return

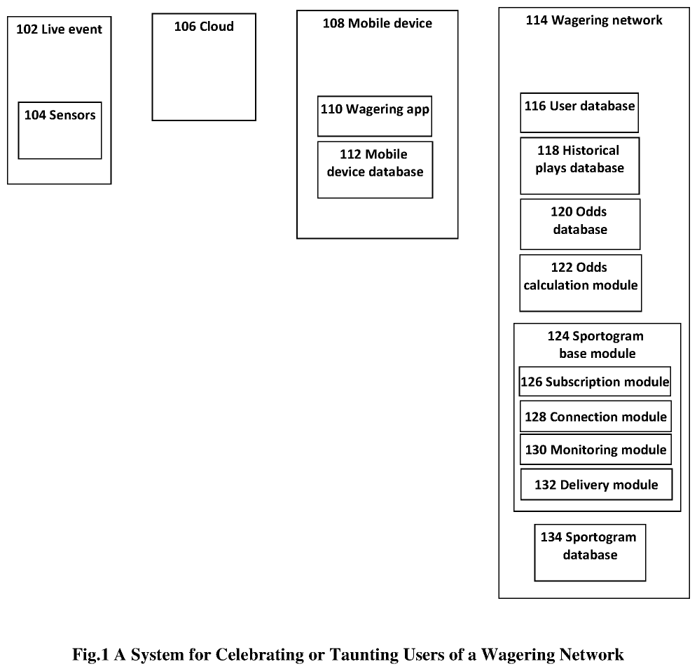

FIG. 1 is a system for celebrating or taunting users of a wagering network. This system may include a live event 102, for example, a sporting event such as a football, basketball, baseball, or hockey game, tennis match, golf tournament, eSports, or digital game, etc. The live event 102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 102, such as the score of an American football game or the run line in a baseball game, or a series of actions in the live event 102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 102 or at another location.

Further, embodiments may include a plurality of sensors 104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 114, which may perform real-time analysis on the type of play and the result of the play. The cloud 106 may also be synchronized with game situational data such as the time of the game, the score, location on the field, weather conditions, and the like, which may affect the choice of play utilized. For example, in an exemplary embodiment, the cloud 106 may not receive data gathered from the sensors 104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and may be utilized in a situation where a paired wearable device employs the mobile device 108 for additional memory or computing power or connection to the internet.

Further, embodiments may include a wagering software application or a wagering app 110, which is a program that enables the user to place bets on individual plays in the live event 102, streams audio and video from the live event 102, and features the available wagers from the live event 102 on the mobile device 108. The wagering app 110 allows the user to interact with the wagering network 114 to place bets and provide payment/receive funds based on wager outcomes.

Further, embodiments may include a mobile device database 112 that may store some or all the user's data, the live event 102, or the user's interaction with the wagering network 114.

Further, embodiments may include the wagering network 114, which may perform real-time analysis on the type of play and the result of a play or action. The wagering network 114 (or the cloud 106) may also be synchronized with game situational data, such as the time of the game, the score, location on the field, weather conditions, and the like, which may affect the choice of play utilized. For example, in an exemplary embodiment, the wagering network 114 may not receive data gathered from the sensors 104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 116, which may contain data relevant to all users of the wagering network 114 and may include, but is not limited to, a user ID, a device identifier, a paired device identifier, wagering history, or wallet information for the user. The user database 116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 116 may contain betting lines and search queries. The user database 116 may be searched based on a search criterion received from the user. Each betting line may include but is not limited to, a plurality of betting attributes such as at least one of the following: the live event 102, a team, a player, an amount of wager, etc. The user database 116 may include, but is not limited to, information related to all the users involved in the live event 102. In one exemplary embodiment, the user database 116 may include information for generating a user authenticity report and a wagering verification report. Further, the user database 116 may be used to store user statistics like, but not limited to, the retention period for a particular user, frequency of wagers placed by a particular user, the average amount of wager placed by each user, etc.

Further, embodiments may include a historical plays database 118 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 120—that may contain the odds calculated by an odds calculation module 122—to display the odds on the user's mobile device 108 and take bets from the user through the mobile device wagering app 110.

Further, embodiments may include the odds calculation module 122, which may utilize historical play data to calculate odds for in-play wagers.

Further, embodiments may include a sportogram base module 124, which may allow users to communicate with each other through pictures or animations related to at least one aspect of a wagered upon live event 102. For example, a first user may have bet on the current play in an American football game resulting in a complete pass. The supposed play may end in a sack of the quarterback. A second user may send a sportogram in the form of an animation of a quarterback being sacked to the first user to taunt the first user. The sportogram base module 126 may prompt the subscription module 126 to allow users to subscribe to one or more libraries of sportograms. The connection module 128 may be prompted to allow users to create connections to one or more other users or a group of users. Both the subscription module 126 and the connection module 128 may be called by a user at any time with or without a live event 102 being active. When one or more live events 102 are active, the monitoring module 130 may monitor the user database 116 for any open wagers. Users or groups of users connected to the user who placed the open wager may be identified. For example, a contact list of a first user who placed a wager on the current play of the Kansas City Chiefs' game that resulted in a pass or the Chiefs winning the game. The monitoring module 130 may identify one or more characteristics of the live event 102 that may be related to the open wager, and the deliver module 132 may be prompted to allow the identified connected users to send one or more sportograms to the user who placed the wager that may be related to the one or more characteristics of the live event 102 that prompted the notification. For example, a contact of the user who placed a wager on the current play of the Kansas City Chiefs' game resulting in a pass may be notified of the play resulting in a sack and can send an animation of a quarterback being sacked to the user who placed the wager.

Further, embodiments may include a subscription module 126, which may allow users to subscribe to one or more libraries of sportograms. For example, a user may pay for access to a library of images or animations related to their favorite team, sport, player, wager type, etc., that they may send to another user when a characteristic of the live event 102 is relevant to at least one placed wager.

Further, embodiments may include a connection module 128 that may allow users to create connections between themselves and other users or groups of users. For example, these connections may allow connected users to send sportograms related to one or more characteristics of the live event 102 and at least one wager to each other.

Further, embodiments may include a monitoring module 130 that may monitor the live event 102 for characteristics related to one or more wagers. When a characteristic of the live event 102 is identified as being related to a placed wager, the monitoring module 130 may notify one or more connected users.

Further, embodiments may include a delivery module 132, which may allow the users to select one or more sportograms related to both a wager placed by a connected user and a characteristic of the live event 102 to send in response to the notification delivered by the monitoring module 130.

Further, embodiments may include a sportogram database 134 that may contain one or more libraries of sprotograms and the users of the wagering network 114 that are subscribed to each library.

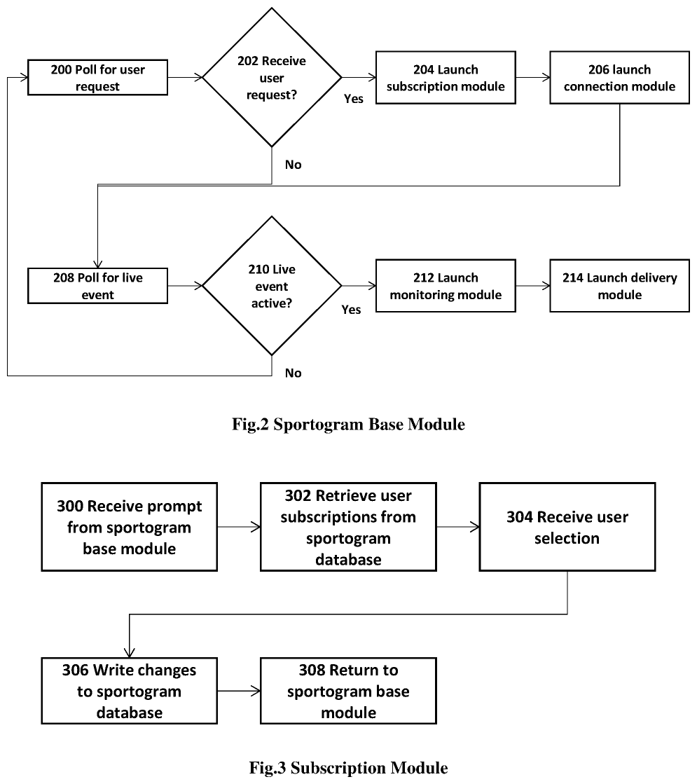

FIG. 2 illustrates the sportogram base module 124. The process may begin with the sportogram base module 124 polling, at step 200, for a user request. For example, a user may request to sign up for a subscription to use the sportograms to send to their connections on the wagering network 114. Then the sportogram base module 124 may determine, at step 202, if a request is received from the user. For example, a user may request to sign up for a subscription to use the sportograms to send to their connections on the wagering network 114. Then the sportogram base module 124 may launch, at step 204, the subscription module 126. For example, the subscription module 126 may begin with the subscription module 126 receiving a prompt from the sportogram base module 124. For example, the sportogram base module 124 may receive a request from a user that they desire to subscribe to the sportograms and the sportogram base module 124 may initiate the subscription module 126. Then the subscription module 126 may retrieve the user subscriptions from the sportogram database 134. For example, the subscription module 126 may use the user ID to filter the sportogram database 134 to determine the sportograms that the user currently has access to. The subscription module 126 may receive the user selection. For example, the user may select from a various list of available sportogram libraries stored in the sportogram database 134, such as sportogram libraries for various sports, teams, players, wager types, etc. Then the subscription module 126 may write the changes to the sportogram database 134. For example, if the user selected baseball, Kansas City Chiefs, or Patrick Mahomes, the subscription module 126 may enter the selection in the sportogram database 134 to allow the user access to the sportograms in those sportogram libraries. Then the subscription module 126 may return to the sportogram base module. The sportogram base module 124 may launch, at step 206, the connection module 128. For example, the connection module 128 may begin with the connection module 128 receiving a prompt from the sportogram base module 124. For example, the user may desire to add or select other users on the wagering network 114 as one of their connected users, such as a friend list, contact list, etc., and the sportogram base module 124 may initiate the connection module 128. Then the connection module 128 may retrieve the user connections from the user database 116. For example, the connection module 128 may filter the user database 116 on the user ID to determine the current users that the user ID is connected to, such as a friends list, contact list, etc. The connection module 128 may receive the user selection. For example, the user may select a user to connect to by selecting a user ID, full name, username, e-mail address, phone number, etc., to add the other user as a connected user. Then the connection module 128 may write the changes to the user database 116. For example, after the user selects another user to connect to the connection, module 128 may store the connected user in the user database 116 so that the user is connected through a contact list, friend list, etc. Then the connection module 128 may return to the sportogram base module 124. If there is no request from the user or after launching the connection module 128, the sportogram base module 124 may continuously poll, at step 208, for the live event 102. For example, the sportogram base module 124 may be determining if there is a live event currently being performed, such as an American football event of the Kansas City Chiefs vs. the Denver Broncos. Then the sportogram base module 124 may determine, at step 210, if the live event 102 is active. If the live event 102 is not active, then the sportogram base module 124 may return to continuously polling for a user request. If the live event 102 is active, then the sportogram base module 124 may launch, at step 212, the monitoring module 130. For example, the monitoring module 130 may begin with the monitoring module 130 receiving a prompt from the sportogram base module 124. For example, the sportogram base module 124 may determine that a live event 102 is currently active and may send the live event 102 data to the monitoring module 130, such as the sport and the teams involved in the live event 102. Then the monitoring module 130 may retrieve the open wagers from the user database 116. For example, the monitoring module 130 may receive the user ID from the sportogram base module 124 and filter the user database 116 on all the open wagers that the user currently has. In some embodiments, the user database 116 may be filtered for the open wagers for the connected users of the user ID, such as users that are in a friends list, contact list, etc. Then the monitoring module 130 may continuously poll for live event characteristics related to the available wagers retrieved from the user database 116. For example, if the user had an open wager that Patrick Mahomes of the Kansas City Chiefs would complete his next pass attempt and in the live event the Kansas City Chiefs have the ball, and the first down has just been completed by Patrick Mahomes throwing a pass to Tyreek Hill, then the related characteristics may be that Patrick Mahomes has just completed a pass. In some embodiments, the related characteristics may be that the Kansas City Chiefs are on offense, first down has just been completed, etc. In some embodiments, the characteristics may be the teams involved, players involved, etc., that are similar to the open wager. The monitoring module 130 may determine if a related characteristic is found. If a related characteristic is not found, then the monitoring module 130 may return to retrieving the open wagers from the user database 116. For example, if the user had an open wager that Patrick Mahomes of the Kansas City Chiefs would complete his next pass attempt and in the live event the Kansas City Chiefs have the ball, and the first down has just been completed by Patrick Mahomes throwing a pass to Tyreek Hill, then the related characteristics may be that Patrick Mahomes has just completed a pass. In some embodiments, the related characteristics may be that the Kansas City Chiefs are on offense, first down has just been completed, etc. In some embodiments, the characteristics may be the teams involved, players involved, etc., that are similar to the open wager. If a related characteristic is found, then the monitoring module 130 may send a prompt to the sportogram base module 124. For example, the prompt that the monitoring module 130 may send to the sportogram base module 124 may be the sport, the team, the players involved, the wager type, etc., that is from the related characteristic. Then the sportogram base module 124 may launch, at step 214, the delivery module 132. For example, the delivery module 132 may begin with the delivery module 132 receiving a prompt from the sportogram base module 124. For example, the prompt that the sportogram base module 124 may send may be the sport, the team, the players involved, the wager type, etc., that is from the related characteristic. Then the delivery module 132 may receive the user sportogram selection. For example, the user may be notified of the related characteristic from an open or closed wager in which, once prompted by the sportogram base module 124, the user may select a sportogram from the available libraries from the sportogram database 134 in which the user has access to through their subscription. The user may select a sportogram from a library that they have access to, and the user may send the sportogram to the connected users, such as users on their friends' list, contact list, etc. In some embodiments, the user may select the connected user they desire to send the sportogram to. In some embodiments, the sportogram database 134 may be filtered using the related characteristics to display the relevant sportograms to the user so that they can quickly send relevant sportograms to their connected users, such as relevant sports sportograms, relevant team sportograms, relevant player sportograms, or related wager type sportograms. Then the delivery module 132 may send the selected sportogram to the user connections. For example, the delivery module 132 may receive the selected sportogram and may send the sportogram to the connected users. In some embodiments, the user may select the connected user they desire to send the sportogram to. In some embodiments, the sportogram database 134 may be filtered using the related characteristics to display the relevant sportograms to the user so that they can quickly send relevant sportograms to their connected users, such as relevant sports sportograms, relevant team sportograms, relevant player sportograms, or related wager type sportograms. The delivery module 132 may return to the sportogram base module 124.

FIG. 3 illustrates the subscription module 126. The process may begin with the subscription module 126, receiving, at step 300, a prompt from the sportogram base module 124. For example, the sportogram base module 124 may receive a request from a user that they desire to subscribe to the sportograms and the sportogram base module 124 may initiate the subscription module 126. Then the subscription module 126 may retrieve, at step 302, the user subscriptions from the sportogram database 134. For example, the subscription module 126 may use the user ID to filter the sportogram database 134 to determine the sportograms that the user currently has access to. The subscription module 126 may receive, at step 304, the user selection. For example, the user may select from a various list of available sportogram libraries stored in the sportogram database 134, such as sportogram libraries for various sports, teams, players, wager types, etc. Then the subscription module 126 may write, at step 306, the changes to the sportogram database 134. For example, if the user selected baseball, Kansas City Chiefs, or Patrick Mahomes, the subscription module 126 may enter the selection in the sportogram database 134 to allow the user access to the sportograms in those sportogram libraries. Then the subscription module 126 may return, at step 308, to the sportogram base module.

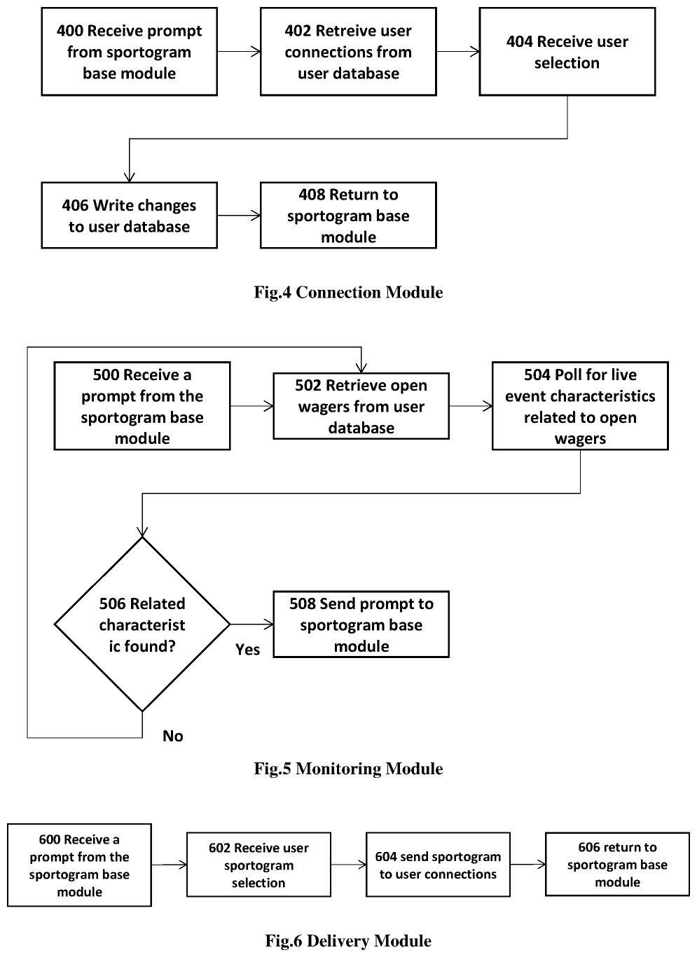

FIG. 4 illustrates the connection module 128. The process may begin with the connection module 128 receiving, at step 400, a prompt from the sportogram base module 124. For example, the user may desire to add or select other users on the wagering network 114 as one of their connected users, such as a friend list, contact list, etc., and the sportogram base module 124 may initiate the connection module 128. Then the connection module 128 may retrieve, at step 402, the user connections from the user database 116. For example, the connection module 128 may filter the user database 116 on the user ID to determine the current users that the user ID is connected to, such as a friends list, contact list, etc. The connection module 128 may receive, at step 404, the user selection. For example, the user may select a user to connect to by selecting a user ID, full name, username, e-mail address, phone number, etc., to add the other user as a connected user. Then the connection module 128 may write, at step 406, the changes to the user database 116. For example, after the user selects another user to connect to the connection, module 128 may store the connected user in the user database 116 so that the user is connected through a contact list, friend list, etc. Then the connection module 128 may return, at step 408, to the sportogram base module 124.

FIG. 5 illustrates the monitoring module 130. The process may begin with the monitoring module 130, receiving, at step 500, a prompt from the sportogram base module 124. For example, the sportogram base module 124 may determine that a live event 102 is currently active and may send the live event 102 data to the monitoring module 130, such as the sport and the teams involved in the live event 102. Then the monitoring module 130 may retrieve, at step 502, the open wagers from the user database 116. For example, the monitoring module 130 may receive the user ID from the sportogram base module 124 and filter the user database 116 on all the open wagers that the user currently has. In some embodiments, the user database 116 may be filtered for the open wagers for the connected users of the user ID, such as users that are in a friends list, contact list, etc. Then the monitoring module 130 may continuously poll, at step 504, for live event characteristics related to the available wagers retrieved from the user database 116. For example, if the user had an open wager that Patrick Mahomes of the Kansas City Chiefs would complete his next pass attempt and in the live event the Kansas City Chiefs have the ball, and the first down has just been completed by Patrick Mahomes throwing a pass to Tyreek Hill, then the related characteristics may be that Patrick Mahomes has just completed a pass. In some embodiments, the related characteristics may be that the Kansas City Chiefs are on offense, first down has just been completed, etc. In some embodiments, the characteristics may be the teams involved, players involved, etc., that are similar to the open wager. The monitoring module 130 may determine, at step 506, if a related characteristic is found. If a related characteristic is not found, then the monitoring module 130 may return to retrieving the open wagers from the user database 116 at step 502. For example, if the user had an open wager that Patrick Mahomes of the Kansas City Chiefs would complete his next pass attempt and in the live event the Kansas City Chiefs have the ball, and the first down has just been completed by Patrick Mahomes throwing a pass to Tyreek Hill, then the related characteristics may be that Patrick Mahomes has just completed a pass. In some embodiments, the related characteristics may be that the Kansas City Chiefs are on offense, first down has just been completed, etc. In some embodiments, the characteristics may be the teams involved, players involved, etc., that are similar to the open wager. If there is a related characteristic, then the monitoring module 130 may send, at step 508, a prompt to the sportogram base module 124. For example, the prompt that the monitoring module 130 may send to the sportogram base module 124 may be the sport, the team, the players involved, the wager type, etc., that is from the related characteristic.

FIG. 6 illustrates the delivery module 132. The process may begin with the delivery module 132, receiving, at step 600, a prompt from the sportogram base module 124. For example, the prompt that the sportogram base module 124 may send may be the sport, the team, the players involved, the wager type, etc., that is from the related characteristic. Then the delivery module 132 may receive, at step 602, the user sportogram selection. For example, the user may be notified of the related characteristic from an open or closed wager in which, once prompted by the sportogram base module 124, the user may select a sportogram from the available libraries from the sportogram database 134 in which the user has access to through their subscription. The user may select a sportogram from a library that they have access to, and the user may send the sportogram to the connected users, such as users on their friends' list, contact list, etc. In some embodiments, the user may select the connected user they desire to send the sportogram to. In some embodiments, the sportogram database 134 may be filtered using the related characteristics to display the relevant sportograms to the user so that they can quickly send relevant sportograms to their connected users, such as relevant sports sportograms, relevant team sportograms, relevant player sportograms, or related wager type sportograms. Then the delivery module 132 may send, at step 604, the selected sportogram to the user connections. For example, the delivery module 132 may receive the selected sportogram and may send the sportogram to the connected users. In some embodiments, the user may select the connected user they desire to send the sportogram to. In some embodiments, the sportogram database 134 may be filtered using the related characteristics to display the relevant sportograms to the user so that they can quickly send relevant sportograms to their connected users, such as relevant sports sportograms, relevant team sportograms, relevant player sportograms, or related wager type sportograms. The delivery module 132 may return, at step 606, to the sportogram base module 124.

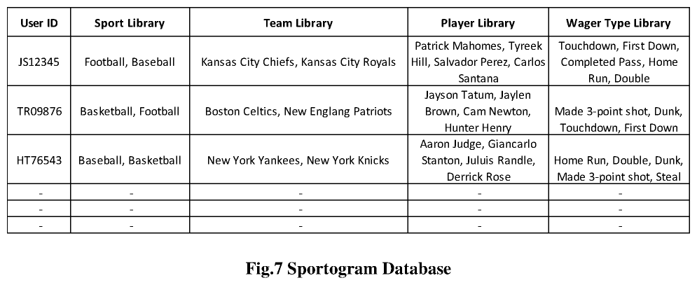

FIG. 7 illustrates the sportogram database 134. The database may contain one or more libraries of sportograms and the users of the wagering network 114 that are subscribed to each library. For example, the sportogram database 134 may contain a list of user IDs, such as JS12345, and the available sportogram libraries that the user has access to, for example, the sportogram sports libraries, such as baseball, basketball, football, etc., the team sportogram libraries, such as the Kansas City Chiefs, Kansas City Royals, etc., the individual player sportogram libraries, such as Patrick Mahomes, Tyreek Hill, etc., the wager type sportogram libraries, such as touchdown, first down, etc. In addition, the sportograms may be pictures or animations. For example, the different sportogram libraries may contain pictures or animations of sports, such as baseball, basketball, football, etc., a specific team, such as the Kansas City Chiefs, Kansas City Royals, etc., a specific player, such as Patrick Mahomes, Tyreek Hill, etc., a wager type, such as touchdown, first down, etc.

The foregoing description and accompanying figures illustrate the principles, preferred embodiments, and modes of operation of the invention. However, the invention should not be construed as being limited to the embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for communicating with users on a sport wagering network, comprising:
receiving at least one of subscription request data, sportogram selection data, and connection selection data from a wagering application;
retrieving at least subscription data from a sportogram database;
retrieving at least connection data from a user database;
determining at least one live event characteristic related to an available wager;
notifying the wagering application about at least one live event characteristic related to an available wager; and
connecting to at least one user on the wagering network and delivering at least one sportogram selection data.

2. The method for communicating with users on a sport wagering network of claim 1, wherein the subscription request data further comprises establishing at least one subscription to at least one sportogram library.

3. The method for communicating with users on a sport wagering network of claim 1, wherein the sportogram selection data further comprises at least an image, an animation, a gif, and a sportogram sport library.

4. The method for communicating with users on a sport wagering network of claim 2, wherein the sportogram library further comprises at least one of a baseball sportogram sport library, a basketball sportogram sport library, a football sportogram sport library, and a soccer sportogram sport library.

5. The method for communicating with users on a sport wagering network of claim 1, wherein the connection data further comprises at least one additional user to connect to on the sport wagering network.

6. The method for communicating with users on a sport wagering network of claim 1, further comprising at least one of selecting, adding, editing, or removing at least one user connection.

7. The method for communicating with users on a sport wagering network of claim 1, wherein the subscription data further comprises at least one list detailing access to at least one or more sportogram library.

8. The method for communicating with users on a sport wagering network of claim 1, wherein the live event characteristic related to an available wager further comprises at least one of live event game data, team data, and player data.

9. The method for communicating with users on a sport wagering network of claim 1, wherein delivering the sportogram selection data further comprises utilizing at least a notification, a banner, a text message, a pop-up, an image, a gif, and an animation.

10. A system for communication among users on a sport wagering network, comprising:
a sportogram base module;
a subscription module;
a connection module;
a monitoring module;
a delivery module; and
a sportogram database; wherein
the sportogram base module is configured to poll and receive at least one user request, initiate the subscription module, initiate the connection module, poll for the end of at least one live event, determine if the live event is active, initiate the monitoring module, and initiate the delivery module;
the subscription module is configured to retrieve at least one subscription from the sportogram database, receive at least one user selection, and write at least one change to the sportogram database;
the connection module is configured to retrieve at least one user connection from a user database, receive at least one user selection, and write at least one change to the user database;
the monitoring module is configured to retrieve at least one open wager from the user database, poll for at least one live event characteristic related to the open wager, determine if the live event characteristic was found, and send at least one prompt to the sportogram base wagering module;
the delivery module is configured to receive at least one user sportogram selection and send at least one user sportogram selection to a user connection; and
the sportogram database is configured to contain at least one library of sportograms and at least one user subscribed to a library.

11. The system for communication among users on a sport wagering network of claim 10, wherein the library of sportograms within the sportogram database is further configured to be at least one of a baseball sportogram sport library, a basketball sportogram sport library, a football sportogram sport library, and a soccer sportogram sport library.

12. The system for communication among users on a sport wagering network of claim 10, wherein a sportogram is further configured to be at least an image, an animation, a gif, and a sportogram sport library.
